(19) United States
(12) Patent Application Publication
(10) Pub. No.: US 2023/0319236 A1
(43) Pub. Date: Oct. 5, 2023

(54) IMAGE SELECTION APPARATUS, PORTABLE TERMINAL, IMAGE SELECTION METHOD, AND NON-TRANSITORY COMPUTER-READABLE MEDIUM

(71) Applicant: NEC Corporation, Minato-ku, Tokyo (JP)

(72) Inventor: Shoji Nishimura, Tokyo (JP)

(73) Assignee: NEC Corporation, Minato-ku, Tokyo (JP)

(21) Appl. No.: 18/010,318

(22) PCT Filed: Jun. 18, 2020
(86) PCT No.: PCT/JP2020/023960

§ 371 Date: Dec. 14, 2022

(51) Int. Cl. H04N 7/18; G06V 20/52; G06V 10/94

(52) U.S. Cl. CPC H04N 7/181; G06V 20/52; G06V 10/945

(57) ABSTRACT

When a user of a terminal (10) desires to view a desired image, the user inputs a selection condition of the image to the terminal (10). Then, the terminal (10) encodes the selection condition, and displays code information on a screen. Then, when the user causes a capturing apparatus (20) to capture an image of the screen, an image selection apparatus (30) recognizes the selection condition by processing the image (first image). Then, the image selection apparatus (30) transmits an image (second image) that satisfies the selection condition to a predetermined terminal, for example, the terminal (10) that displays the code information.

### TECHNICAL FIELD

The present invention relates to an image selection apparatus, a portable terminal, an image selection method, a display control method, and a program.

### BACKGROUND ART

In recent years, a capturing apparatus is installed at various places. An image generated by the capturing apparatus is used for various purposes. In order for a user to use an image, the user needs to select a desired image. For example, Patent Document 1 describes that a position and a time at which an image is generated are used as a condition for searching for the image.

Patent Document 2 describes that, when it is determined that an abnormality occurs in a surveyed person in a surveillance system using an image, the abnormality and an image at that time are notified to an external terminal apparatus.

Further, Patent Document 3 describes a technique for allowing a surveillance camera and a portable terminal to communicate with each other by a management server. Specifically, the portable terminal transmits identification information about the portable terminal in advance to the management server. Then, a user of the portable terminal displays a QR code (registered trademark) including the identification information about the portable terminal on the portable terminal, and causes the surveillance camera to capture an image of the QR code. The management server determines the portable terminal to be allowed to communicate with the surveillance camera that generates the image by processing the image.

### RELATED DOCUMENT

### Patent Document

Patent Document 1: International Publication No. WO2012/014473

Patent Document 2: International Publication No. WO2016/175109

Patent Document 3: International Publication No. WO2019/017082

### SUMMARY OF THE INVENTION

### Technical Problem

A person present near a capturing apparatus may desire to confirm, on the spot, an image generated by the capturing apparatus or another capturing apparatus. One of challenges to be solved by the present invention is to allow a person present near a capturing apparatus to confirm, on the spot, an image generated by the capturing apparatus or another capturing apparatus.

### Solution to Problem

The present invention provides an image selection apparatus including:
an image acquisition unit that acquires a first image including selection information indicating a selection condition used when an image is selected;
an image processing unit that determines the selection condition by processing the first image;
an image selection unit that selects at least one second image that satisfies the selection condition from a plurality of search target images; and
a communication unit that transmits the at least one second image to a transmission destination terminal.

The present invention provides a portable terminal including:
a selection condition acquisition unit that acquires a selection condition for selecting an image;
an encoding unit that encodes the selection condition, and generates code information; and
a display control unit that displays the code information on a screen.

The present invention provides an image selection method including,
executing by a computer:
image acquisition processing of acquiring a first image including selection information indicating a selection condition used when an image is selected;
image processing of determining the selection condition by processing the first image;
image selection processing of selecting at least one second image that satisfies the selection condition from a plurality of search target images; and
image transmission processing of transmitting the at least one second image to a transmission destination terminal.

The present invention provides a display control method including,
executing by a computer mounted on a portable terminal:
selection condition acquisition processing of acquiring a selection condition for selecting an image;
encoding processing of encoding the selection condition, and generating code information; and
display control processing of displaying the code information on a screen of the portable terminal.

The present invention provides a program causing a computer to include:
an image acquisition function of acquiring a first image including selection information indicating a selection condition used when an image is selected;
an image processing function of determining the selection condition by processing the first image;
an image selection function of selecting at least one second image that satisfies the selection condition from a plurality of search target images; and
an image transmission function of transmitting the at least one second image to a transmission destination terminal.

The present invention provides a program causing a computer mounted on a portable terminal to include:
a selection condition acquisition function of acquiring a selection condition for selecting an image;
an encoding function of encoding the selection condition, and generating code information; and
a display control function of displaying the code information on a screen of the portable terminal.

### Advantageous Effects of Invention

According to the present invention, a person present near a capturing apparatus can confirm, on the spot, an image generated by the capturing apparatus or another capturing apparatus.

### BRIEF DESCRIPTION OF THE DRAWINGS

The above-described object, the other objects, features, and advantages will become more apparent from suitable example embodiments described below and the following accompanying drawings.

FIG. 1 is diagram for describing a usage environment of a terminal and an image selection apparatus according to an example embodiment.

FIG. 2 is a diagram illustrating one example of a functional configuration of the terminal.

FIG. 3 is a diagram illustrating one example of a functional configuration of the image selection apparatus.

FIG. 4 is a diagram illustrating one example of a data configuration of an image storage unit.

FIG. 5 is a diagram illustrating a hardware configuration example of the image selection apparatus.

FIG. 6 is a flowchart illustrating one example of processing performed by the terminal and the image selection apparatus.

FIG. 7 is a diagram illustrating one example of a functional configuration of the terminal according to a modification example.

### DESCRIPTION OF EMBODIMENTS

Hereinafter, example embodiments of the present invention will be described with reference to the drawings. Note that, in all of the drawings, a similar component has a similar reference sign, and description thereof will not be repeated as appropriate.

### Example Embodiment

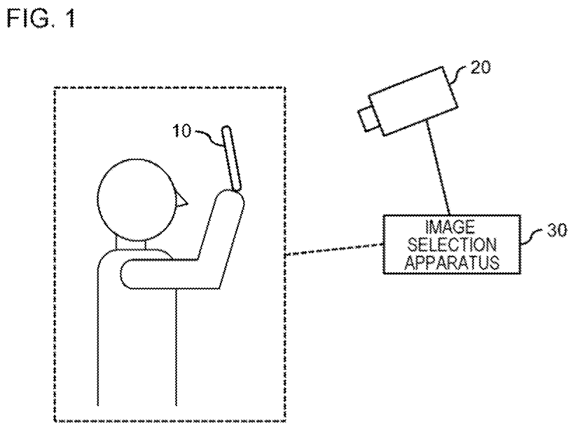

FIG. 1 is diagram for describing a usage environment of a terminal 10 and an image selection apparatus 30 according to an example embodiment. The terminal 10 and the image selection apparatus 30 are used together with a capturing apparatus 20.

The capturing apparatus 20 is an apparatus for purposes of surveillance and security, for example. A position of the capturing apparatus 20 may be inside or may be outside. The capturing apparatus 20 may be fixed in the position or may be movable. Any frame rate of an image generated by the capturing apparatus 20 may be used.

An image generated by the capturing apparatus 20 is transmitted, to the image selection apparatus 30, together with information (hereinafter described as date and time information) that can determine a date and time at which the image is generated, such as a date and time itself and a frame number. The image selection apparatus 30 stores the image generated by the capturing apparatus 20 in association with date information in an image storage unit 350 described below. Further, the image selection apparatus 30 selects an image (hereinafter described as a second image) that needs to be displayed on the terminal 10 from the image stored in the image storage unit 350, i.e., a search target image, and transmits the selected second image to the terminal 10. The second image transmitted to the terminal 10 may be one or may be plural.

A selection condition of an image is displayed on a screen of the terminal 10. The image selection apparatus 30 recognizes the selection condition by analyzing an image (hereinafter described as a first image) including the screen of the terminal 10 among the images generated by the capturing apparatus 20. In the present example embodiment, the selection condition is encoded. A code used herein is, for example, a two-dimensional code, but may be one-dimensional code such as a bar code. Note that, the terminal 10 is, for example, a portable terminal, such as a so-called smartphone or a tablet terminal. However, the terminal 10 may be a fixed terminal.

In the example described above, the image selection apparatus 30 transmits the second image to the terminal 10 that displays the selection condition. However, the image selection apparatus 30 may transmit an image after a selection to a terminal different from the terminal 10 that displays the selection condition. In both of the cases, the terminal 10 also displays, together with the selection condition, information (hereinafter described as transmission destination determination information) that determines the terminal (hereinafter described as a transmission destination terminal) being a transmission destination on the screen of the terminal 10. When the selection condition is encoded, the transmission destination determination information is preferably included in the code.

Further, FIG. 1 illustrates only one capturing apparatus 20. However, the image selection apparatus 30 may communicate with a plurality of the capturing apparatuses 20. In this case, the capturing apparatus 20 transmits, to the image selection apparatus 30, a generated image together with information (hereinafter described as capturing apparatus identification information) that identifies the capturing apparatus 20.

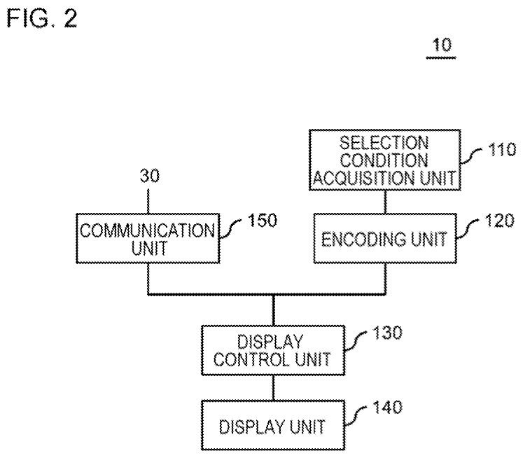

FIG. 2 is a diagram illustrating one example of a functional configuration of the terminal 10. In the example illustrated in FIG. 2, the terminal 10 includes a selection condition acquisition unit 110, an encoding unit 120, and a display control unit 130.

The selection condition acquisition unit 110 acquires the selection condition described above. The selection condition is input by, for example, a user of the terminal 10 operating a user interface (for example, a touch panel). As the selection condition, the following examples can be exemplified. Further, a plurality of the following examples can also be combined.
(1) A date and time at which an image is generated
(1-1) In (1), an image generated from a current time until a predetermined time
(2) A condition that needs to be satisfied by information (analysis result information) acquired by analyzing an image.
(2-1) In (2), the condition that needs to be satisfied by the analysis result information includes a kind of an object
(2-2) In (2-1), the condition that needs to be satisfied by the analysis result information includes the number of objects by kind
(2-2) In (2), the condition that needs to be satisfied by the analysis result information includes at least one of the number and an attribute of a person
(2-3) In (2) or (2-2), the condition that needs to be satisfied by the analysis result information includes at least one of a pose and a movement of a person

The encoding unit 120 encodes the selection condition acquired by the selection condition acquisition unit 110, and generates code information. The display control unit 130 displays the code information generated by the encoding unit 120 on a display unit 140 (for example, a display panel). A code displayed on the display unit 140 is a two-dimensional code as described above, but may be one-dimensional code.

In the example illustrated in FIG. 2, the display unit 140 is a part of the terminal 10. However, the display unit 140 may be a display outside the terminal 10.

Further, the display control unit 130 displays transmission destination determination information about a transmission destination terminal on the display unit 140. When the transmission destination terminal is the terminal 10, the display control unit 130 uses, as the transmission destination determination information, terminal identification information (for example, information that determines an account of an SNS or an e-mail address) about the terminal 10. Further, when the transmission destination terminal is a terminal different from the terminal 10, the display control unit 130 uses, as the transmission destination determination information, information (for example, information that determines an account of an SNS or an e-mail address) for identifying the terminal. For example, the display control unit 130 may set the terminal 10 as a transmission destination terminal as default setting, and may be able to change the transmission destination terminal to another terminal by an input from a user. In this case, information that determines the another terminal is input or selected by the user, for example.

Note that, when an account of an SNS or an e-mail address is used as terminal determination information, the transmission destination determination information may be the account of the SNS or the e-mail address itself, or may be identification information assigned to the account of the SNS or the e-mail address. In the latter case, the image selection apparatus 30 stores the account of the SNS or the e-mail address in advance in association with the identification information assigned to the account of the SNS or the e-mail address. Then, when the image selection apparatus 30 recognizes the identification information as the transmission destination determination information, the image selection apparatus 30 reads and uses the account of the SNS or the e-mail address associated with the identification information.

Note that, the transmission destination determination information is preferably included in the code information generated by the encoding unit 120. In this case, the selection condition acquisition unit 110 acquires the transmission destination determination information.

In the present example embodiment, the terminal 10 further includes a communication unit 150. The communication unit 150 communicates with an external apparatus, for example, the image selection apparatus 30. When the transmission destination terminal is the terminal 10, the communication unit 150 acquires the second image selected by the image selection apparatus 30. Then, the display control unit 130 displays the second image acquired by the communication unit 150 on the display unit 140.

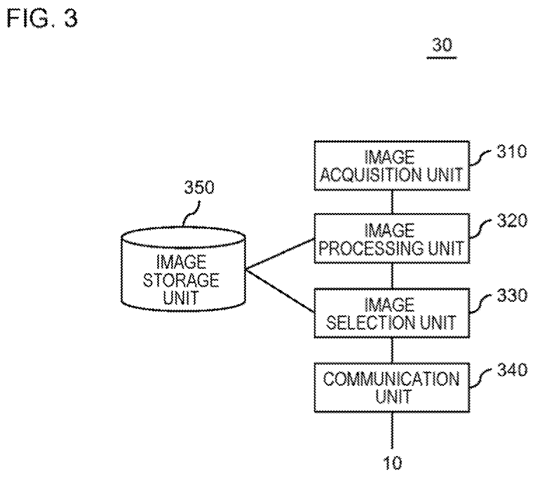

FIG. 3 is a diagram illustrating one example of a functional configuration of the image selection apparatus 30. In the example illustrated in FIG. 3, the image selection apparatus 30 includes an image acquisition unit 310, an image processing unit 320, and an image selection unit 330.

The image acquisition unit 310 acquires the first image generated by the capturing apparatus 20. As described above, the first image includes a code displayed on the display unit 140 of the terminal 10, i.e., information indicating a selection condition for selecting the second image. Note that, when the image selection apparatus 30 communicates with the plurality of capturing apparatuses 20, the image acquisition unit 310 also acquires, together with the first image, capturing apparatus identification information about the capturing apparatus 20 that generates the first image.

The image processing unit 320 determines a selection condition by processing the first image. Specifically, the image processing unit 320 determines a region of the first image associated with the screen of the terminal 10, i.e., a region in which the code is captured, decodes the code by processing the region, and determines the selection condition. Herein, when transmission destination determination information is included in the code, the image processing unit 320 determines the transmission destination determination information by decoding processing. Further, when transmission destination determination information (for example, text data or another code) is located in a region of the first image different from that of the code indicating the selection condition, the image processing unit 320 recognizes the transmission destination determination information by processing the region.

The image selection unit 330 selects at least one second image that satisfies the selection condition from a plurality of images stored in the image storage unit 350, i.e., a plurality of search target images. In the example illustrated in FIG. 3, the image storage unit 350 is a part of the image selection apparatus 30. However, the image storage unit 350 may be located outside the image selection apparatus 30.

A communication unit 340 transmits the second image selected by the image selection unit 330 to a transmission destination terminal, for example, the terminal 10 that generates the first image. Herein, when transmission destination determination information is included in the first image, the communication unit 340 transmits the second image to a terminal indicated by the transmission destination determination information.

Note that, the image acquisition unit 310 also repeatedly acquires an image other than the first image among the images generated by the terminal 10, together with date and time information about the image. Then, the image processing unit 320 generates analysis result information described above by processing the images. Then, the image processing unit 320 stores the image acquired by the image acquisition unit 310 in association with the date and time information and the analysis result information about the image in the image storage unit 350. Note that, when the image selection apparatus 30 communicates with the plurality of capturing apparatuses 20, the image processing unit 320 further stores, in the image storage unit 350, an image generated by the capturing apparatus 20 in association with capturing apparatus identification information about the capturing apparatus 20 that generates the image.

Note that, the analysis result information includes the following information, for example.

(1) A kind of an object and the number of objects for each kind
(2) At least one of the number, an attribute, a pose, and a movement of a person

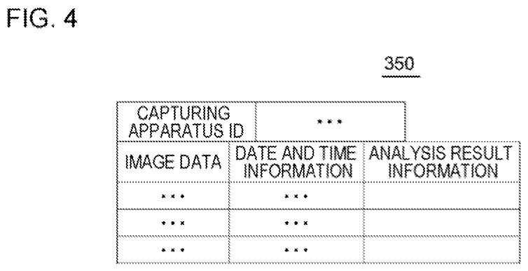

FIG. 4 is a diagram illustrating one example of a data configuration of the image storage unit 350. The image storage unit 350 stores, by the capturing apparatus 20 (i.e., by capturing apparatus identification information), each frame image (described as image data in FIG. 4) generated by the capturing apparatus 20, date and time information about the frame image, and analysis result information about the frame image in association with one another.

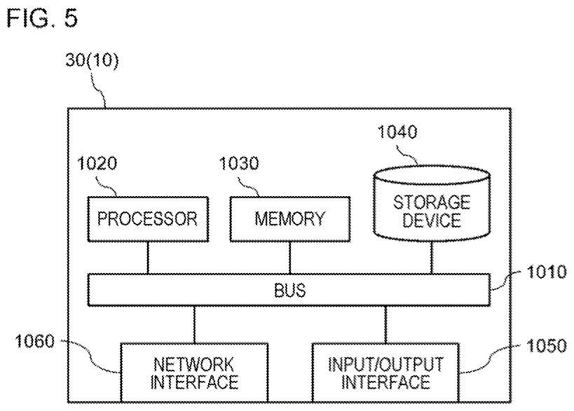

FIG. 5 is a diagram illustrating a hardware configuration example of the image selection apparatus 30. The image selection apparatus 30 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (for example, the image acquisition unit 310, the image processing unit 320, the image selection unit 330, and the communication unit 340) of the image selection apparatus 30. The processor 1020 reads each program module onto the memory 1030 and executes the program module, and each function associated with the program module is achieved. Further, the storage device 1040 may also function as the image storage unit 350.

The input/output interface 1050 is an interface for connecting the image selection apparatus 30 and various types of input/output equipment.

The network interface 1060 is an interface for connecting the image selection apparatus 30 to a network. The network is, for example, a local area network (LAN) and a wide area network (WAN). A method of connection to the network by the network interface 1060 may be wireless connection or wired connection. The image selection apparatus 30 communicates with the terminal and the capturing apparatus 20 via the input/output interface 1060.

Note that, a hardware configuration of the terminal 10 is also similar to the example illustrated in FIG. 5. In this case, the storage device 1040 stores a program module that achieves each function (for example, the selection condition acquisition unit 110, the encoding unit 120, the display control unit 130, and the communication unit 150) of the terminal 10.

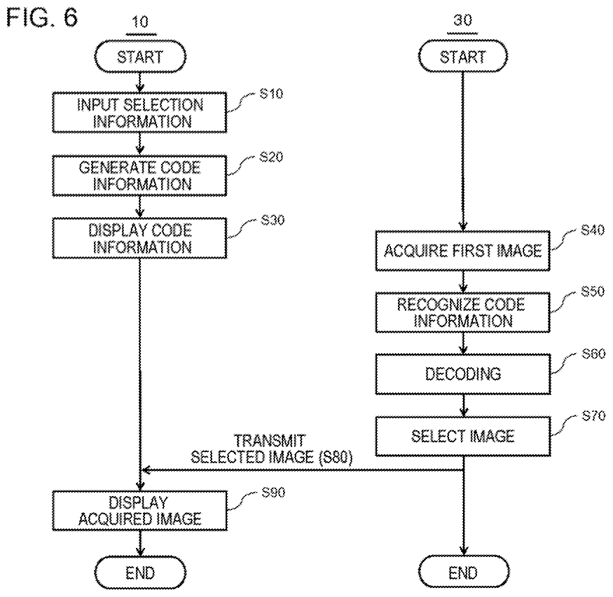

FIG. 6 is a flowchart illustrating one example of processing performed by the terminal 10 and the image selection apparatus 30. Note that, the capturing apparatus 20 transmits, to the image selection apparatus 30, a generated image together with date and time information and capturing apparatus identification information immediately after the generation, regardless of the processing illustrated in FIG. 6. Then, the image processing unit 320 of the image selection apparatus 30 generates analysis result information by processing the image acquired from the capturing apparatus 20, and stores the analysis result information in association with the image, the date and time information, and the capturing apparatus identification information in the image storage unit 350.

Then, a user of the terminal 10 inputs a selection condition of the second image to the terminal 10. The selection condition acquisition unit 110 of the terminal 10 acquires the selection condition (step S10). Then, the encoding unit 120 of the terminal 10 encodes the selection condition, and generates code information. At this time, the encoding unit 120 includes transmission destination information in the code information as necessary (step S20).

Then, the user of the terminal 10 directs the screen of the terminal 10 toward the capturing apparatus 20 in a capturing range of the capturing apparatus 20 while the code information is displayed on the screen (step S30).

Then, an image generated by the capturing apparatus 20 at the timing includes the code information. This image is the first image described above. Then, the image acquisition unit 310 of the image selection apparatus 30 acquires the first image immediately after the first image is generated. At this time, the image acquisition unit 310 may also acquire capturing apparatus identification information about the capturing apparatus 20 (step S40).

The image processing unit 320 of the image selection apparatus 30 determines a region of the first image in which the code information is captured (step S50), decodes the code information, and thus recognizes the selection condition. When the transmission destination information is included in the code information, the image processing unit 320 determines the transmission destination information by decoding. Note that, when the transmission destination information is included in a different region of the first image from that of the code information, the image processing unit 320 determines the transmission destination information by processing the region (step S60).

Then, the image selection unit 330 selects at least one second image by using the selection condition determined in step S60 (step S70), and transmits the selected second image to the terminal (in the example illustrated in FIG. 6, the terminal 10 that generates the code information) indicated by the transmission destination information (step S80).

Then, the terminal 10 displays the second image received from the image selection apparatus 30 (step S90).

Note that, the processing illustrated in FIG. 6 is performed when, for example, a person in a capturing range of the capturing apparatus 20 desires to know a past state of the capturing range. In this case, when the image selection apparatus 30 is connected to the plurality of capturing apparatuses 20, in step S70, the image selection unit 330 selects the second image from images in association with the capturing apparatus identification information acquired in step S40 among the images stored in the image storage unit 350.

As described above, according to the present example embodiment, when a user of the terminal 10 desires to view a desired image, the user inputs a selection condition of the image to the terminal 10. Then, the terminal 10 encodes the selection condition, and displays code information on the screen. Then, when the user causes the capturing apparatus 20 to capture an image of the screen, the image selection apparatus 30 recognizes the selection condition by processing the image (the first image described above). Then, the image selection apparatus 30 transmits an image (the second image described above) that satisfies the selection condition to a predetermined terminal, for example, the terminal 10 that displays the code information. Thus, a person present near the capturing apparatus can confirm, on the spot, an image generated by the capturing apparatus or another capturing apparatus.

### Modification Example

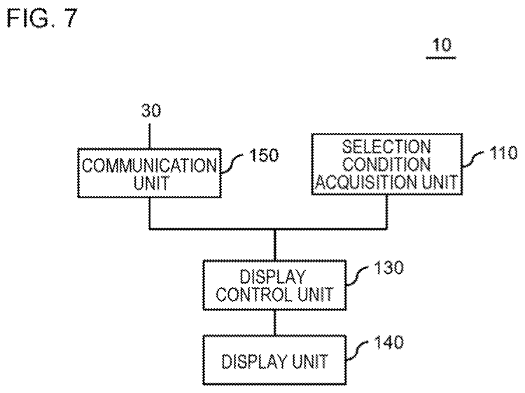

FIG. 7 is a diagram illustrating one example of a functional configuration of the terminal 10 according to a modification example. The terminal 10 illustrated in FIG. 7 is similar to the terminal 10 according to the example embodiment except for a point that the terminal 10 illustrated in FIG. 7 does not include the encoding unit 120. In the example illustrated in FIG. 7, the display control unit 130 displays selection information in a state of text data on the display unit 140. Further, the display control unit 130 displays transmission destination information in a state of text data on the display unit 140 as necessary.

Then, the image processing unit 320 of the image selection apparatus 30 recognizes the selection information by character recognition processing. When the display unit 140 also displays the transmission destination information, the image processing unit 320 also recognizes the transmission destination information by character recognition processing.

The present modification example can also acquire an effect similar to that in the example embodiment.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

A part or the whole of the above-described example embodiment may also be described in supplementary notes below, which is not limited thereto.
1. An image selection apparatus including:
   an image acquisition unit that acquires a first image including selection information indicating a selection condition used when an image is selected;
   an image processing unit that determines the selection condition by processing the first image;
   an image selection unit that selects at least one second image that satisfies the selection condition from a plurality of search target images; and
   a communication unit that transmits the at least one second image to a transmission destination terminal.
2. The image selection apparatus according to supplementary note 1 described above, wherein
   the selection information is code information, and
   the image processing unit recognizes the code information by processing the first image, and determines the selection condition by decoding the code information.
3. The image selection apparatus according to supplementary note 1 or 2 described above, wherein
   the selection information in the first image is displayed on a screen.
4. The image selection apparatus according to supplementary note 3 described above, wherein
   the screen is included in a portable terminal.
5. The image selection apparatus according to any one of supplementary notes 1 to 4 described above, wherein
   the first image further includes transmission destination determination information that determines the transmission destination terminal,
   the image processing unit determines the transmission destination determination information by processing the first image, and
   the communication unit transmits the at least one second image to the transmission destination terminal determined by the transmission destination determination information.
6. The image selection apparatus according to any one of supplementary notes 1 to 5 described above, wherein
   the search target image is associated with date and time information indicating a date and time at which the search target image is generated, and
   the selection condition includes a specification of a date and time.
7. The image selection apparatus according to any one of supplementary notes 1 to 6 described above, wherein
   the search target image is associated with analysis result information being information acquired by analyzing the search target image, and
   the selection condition includes a condition that needs to be satisfied by the analysis result information.
8. The image selection apparatus according to supplementary note 7 described above, wherein
   the analysis result information includes a pose or a movement of a person.
9. The image selection apparatus according to any one of supplementary notes 1 to 8 described above, wherein
   the search target image is generated by a capturing apparatus for surveillance.
10. The image selection apparatus according to supplementary note 9 described above, wherein
   there are a plurality of the capturing apparatuses,
   the search target image is associated with capturing apparatus identification information that identifies the capturing apparatus that generates the search target image,
   the first image is generated by any of the capturing apparatuses,
   the image acquisition unit acquires the first image together with the capturing apparatus identification information about the capturing apparatus that generates the first image, and
   the image selection unit selects the second image from the search target image associated with the capturing apparatus identification information acquired by the image acquisition unit.
11. A portable terminal including:
   a selection condition acquisition unit that acquires a selection condition for selecting an image;
   an encoding unit that encodes the selection condition, and generates code information; and
   a display control unit that displays the code information on a screen.
12. The portable terminal according to supplementary note 11 described above, further including
   a communication unit that acquires an image selected by using the selection condition from an external apparatus after the display control unit displays the code information on the screen, wherein
   the display control unit displays the image acquired by the communication unit on the screen.
13. An image selection method including,
   executing by a computer:
   image acquisition processing of acquiring a first image including selection information indicating a selection condition used when an image is selected;
   image processing of determining the selection condition by processing the first image;
   image selection processing of selecting at least one second image that satisfies the selection condition from a plurality of search target images; and
   image transmission processing of transmitting the at least one second image to a transmission destination terminal.
14. The image selection method according to supplementary note 13 described above, wherein
   the selection information is code information,
   the image selection method further including, in the image processing, by the computer, recognizing the code information by processing the first image, and determines the selection condition by decoding the code information.
15. The image selection method according to supplementary note 13 or 14 described above, wherein
   the selection information in the first image is displayed on a screen.
16. The image selection method according to supplementary note 15 described above, wherein
   the screen is included in a portable terminal.
17. The image selection method according to any one of supplementary notes 13 to 16 described above, wherein
   the first image further includes transmission destination determination information that determines the transmission destination terminal,
   the image selection method further including:
      in the image processing, by the computer, determining the transmission destination determination information by processing the first image; and
      in the communication processing, by the computer, transmitting the at least one second image to the transmission destination terminal determined by the transmission destination determination information.
18. The image selection method according to any one of supplementary notes 13 to 17 described above, wherein
   the search target image is associated with date and time information indicating a date and time at which the search target image is generated, and
   the selection condition includes a specification of a date and time.
19. The image selection method according to any one of supplementary notes 13 to 18 described above, wherein
   the search target image is associated with analysis result information being information acquired by analyzing the search target image, and
   the selection condition includes a condition that needs to be satisfied by the analysis result information.
20. The image selection method according to supplementary note 19 described above, wherein
   the analysis result information includes a pose or a movement of a person.
21. The image selection method according to any one of supplementary notes 13 to 20 described above, wherein
   the search target image is generated by a capturing apparatus for surveillance.
22. The image selection method according to supplementary note 21 described above, wherein
   there are a plurality of the capturing apparatuses,
   the search target image is associated with capturing apparatus identification information that identifies the capturing apparatus that generates the search target image, and
   the first image is generated by any of the capturing apparatuses,
   the image selection method further including:
      in the image acquisition processing, by the computer, acquiring the first image together with the capturing apparatus identification information about the capturing apparatus that generates the first image; and
      in the image selection processing, by the computer, selecting the second image from the search target image associated with the capturing apparatus identification information acquired in the image acquisition processing.
23. A display control method including,
   executing by a computer mounted on a portable terminal:
   selection condition acquisition processing of acquiring a selection condition for selecting an image;
   encoding processing of encoding the selection condition, and generating code information; and
   display control processing of displaying the code information on a screen of the portable terminal.
24. A portable terminal in the display control method according to supplementary note 23 described above, including:
   in the display control processing, by the computer, further performing communication processing of acquiring an image selected by using the selection condition from an external apparatus after displaying the code information on the screen; and,
   in the display control processing, by the computer, displaying the image acquired in the communication processing on the screen.
25. A program causing a computer to include:
   an image acquisition function of acquiring a first image including selection information indicating a selection condition used when an image is selected;
   an image processing function of determining the selection condition by processing the first image;
   an image selection function of selecting at least one second image that satisfies the selection condition from a plurality of search target images; and
   an image transmission function of transmitting the at least one second image to a transmission destination terminal.
26. The program according to supplementary note 25 described above, wherein
   the selection information is code information, and
   the image processing function recognizes the code information by processing the first image, and determines the selection condition by decoding the code information.
27. The program according to supplementary note 25 or 26 described above, wherein
   the selection information in the first image is displayed on a screen.
28. The program according to supplementary note 27 described above, wherein
   the screen is included in a portable terminal.
29. The program according to any one of supplementary notes 25 to 28 described above, wherein
   the first image further includes transmission destination determination information that determines the transmission destination terminal,
   the image processing function determines the transmission destination determination information by processing the first image, and
   the communication function transmits the at least one second image to the transmission destination terminal determined by the transmission destination determination information.
30. The program according to any one of supplementary notes 25 to 29 described above, wherein
   the search target image is associated with date and time information indicating a date and time at which the search target image is generated, and
   the selection condition includes a specification of a date and time.
31. The program according to any one of supplementary notes 25 to 30 described above, wherein
   the search target image is associated with analysis result information being information acquired by analyzing the search target image, and
   the selection condition includes a condition that needs to be satisfied by the analysis result information.
32. The program according to supplementary note 31 described above, wherein
   the analysis result information includes a pose or a movement of a person.
33. The program according to any one of supplementary notes 25 to 32 described above, wherein
   the search target image is generated by a capturing apparatus for surveillance.
34. The program according to supplementary note 33 described above, wherein
   there are a plurality of the capturing apparatuses,
   the search target image is associated with capturing apparatus identification information that identifies the capturing apparatus that generates the search target image,
   the first image is generated by any of the capturing apparatuses,
   the image acquisition function acquires the first image together with the capturing apparatus identification information about the capturing apparatus that generates the first image, and
   the image selection function selects the second image from the search target image associated with the capturing apparatus identification information acquired by the image acquisition function.
35. A program causing a computer mounted on a portable terminal to include:
   a selection condition acquisition function of acquiring a selection condition for selecting an image;
   an encoding function of encoding the selection condition, and generating code information; and
   a display control function of displaying the code information on a screen of the portable terminal.
36. A portable terminal in the program according to supplementary note 35 described above, causing the computer to include:
   a communication function of acquiring an image selected by using the selection condition from an external apparatus after the display control function displays the code information on the screen, wherein
   the display control function displays the image acquired by the communication function on the screen.

### REFERENCE SIGNS LIST

10 Terminal
20 Capturing apparatus
30 Image selection apparatus
110 Selection condition acquisition unit
120 Encoding unit
130 Display control unit
140 Display unit
150 Communication unit
310 Image acquisition unit
320 Image processing unit
330 Image selection unit
340 Communication unit
350 Image storage unit

What is claimed is:

1. An image selection apparatus comprising:
at least one memory configured to store instructions; and
at least one processor configured to execute the instructions to perform operations comprising:
acquiring a first image including selection information indicating a selection condition used when an image is selected;
determining the selection condition by processing the first image;
selecting at least one second image that satisfies the selection condition from a plurality of search target images; and
transmitting the at least one second image to a transmission destination terminal.

2. The image selection apparatus according to claim 1, wherein
the selection information is code information, and
the operations comprise recognizing the code information by processing the first image, and determining the selection condition by decoding the code information.

3. The image selection apparatus according to claim 1, wherein
the selection information in the first image is displayed on a screen.

4. The image selection apparatus according to claim 3, wherein
the screen is included in a portable terminal.

5. The image selection apparatus according to claim 1, wherein
the first image further includes transmission destination determination information that determines the transmission destination terminal,
the operations comprise
determining the transmission destination determination information by processing the first image, and
transmitting the at least one second image to the transmission destination terminal determined by the transmission destination determination information.

6. The image selection apparatus according to claim 1, wherein
the search target image is associated with date and time information indicating a date and time at which the search target image is generated, and
the selection condition includes a specification of a date and time.

7. The image selection apparatus according to claim 1, wherein
the search target image is associated with analysis result information being information acquired by analyzing the search target image, and
the selection condition includes a condition that needs to be satisfied by the analysis result information.

8. The image selection apparatus according to claim 7, wherein
the analysis result information includes a pose or a movement of a person.

9. The image selection apparatus according to claim 1, wherein
the search target image is generated by a capturing apparatus for surveillance.

10. The image selection apparatus according to claim 9, wherein
there are a plurality of the capturing apparatuses,
the search target image is associated with capturing apparatus identification information that identifies the capturing apparatus that generates the search target image,
the first image is generated by any of the capturing apparatuses,
the operations comprise
acquiring the first image together with the capturing apparatus identification information about the capturing apparatus that generates the first image, and
selecting the second image from the search target image associated with the acquired capturing apparatus identification information.

11. A portable terminal comprising:
at least one memory configured to store instructions; and
at least one processor configured to execute the instructions to perform operations comprising:
acquiring a selection condition for selecting an image;
encoding the selection condition, and generating code information; and
displaying the code information on a screen.

12. The portable terminal according to claim 11, wherein the operations comprise
acquiring an image selected by using the selection condition from an external apparatus after displaying the code information on the screen,
displaying the acquired image on the screen.

13. An image selection method comprising,
executing by a computer:
image acquisition processing of acquiring a first image including selection information indicating a selection condition used when an image is selected;
image processing of determining the selection condition by processing the first image;
image selection processing of selecting at least one second image that satisfies the selection condition from a plurality of search target images; and
image transmission processing of transmitting the at least one second image to a transmission destination terminal.

14. (canceled)

15. A non-transitory computer-readable medium storing a program causing a computer to execute the image selection method according to claim 13.

16. (canceled)
